(19) United States
(12) Patent Application Publication
(10) Pub. No.: US 2024/0408711 A1
(43) Pub. Date: Dec. 12, 2024

(54) DUST TUBE ASSEMBLY FOR A DUST EXTRACTOR

(71) Applicant: MILWAUKEE ELECTRIC TOOL CORPORATION, Brookfield, WI (US)

(72) Inventors: Bryan C. Kendall, Lisbon, WI (US); Taylor Crabb, Menomonee Falls, WI (US)

(21) Appl. No.: 18/697,594

(22) PCT Filed: Oct. 27, 2022
(86) PCT No.: PCT/US2022/047981

§ 371 Date: Apr. 1, 2024

Related U.S. Application Data
(60) Provisional application No. 63/272,496, filed on Oct. 27, 2021.

(51) Int. Cl. B23Q 11/00; B25D 16/00

(52) U.S. Cl. CPC B23Q 11/0071; B23Q 11/0046; B25D 16/00; B25D 2217/0065

(57) ABSTRACT

A dust extractor including a nozzle, an extractor housing, a dust tube coupled to the nozzle and slidable between an extended position and a retracted position relative to the extractor housing, and a dust container selectively coupled to the dust extractor housing. A transfer tube is configured to direct air from the dust tube to the dust container, wherein the dust tube includes a cut-out portion aligned with the transfer tube and a cover slidably coupled to the dust tube to selectively enclose the cut-out portion.

### CROSS-REFERENCE TO RELATED APPLICATIONS

This application claims priority to U.S. Provisional Application No. 63/272,496, filed on Oct. 27, 2021, and entitled “Dust Tube Assembly for A Dust Extractor,” the contents of which are hereby incorporated by reference in their entirety.

### FIELD OF THE INVENTION

The present invention relates to power tools, and more particularly to dust collection assemblies for use with power tools.

### BACKGROUND OF THE INVENTION

Dust collection assemblies are typically used in tandem with hand-held drilling tools, such as rotary hammers, to collect dust and other debris during a drilling operation preventing dust and other debris from accumulating at a worksite. Such dust collection assemblies may be attached to a rotary hammer to position a suction inlet of the collector proximate a drill bit attached to the rotary hammer. Such dust collection assemblies may also include an on-board dust container in which dust and other debris is accumulated. Such dust containers are often removable from the dust collection assembly to facilitate disposal of the accumulated dust and debris.

### SUMMARY OF THE INVENTION

The present disclosure provides, in one aspect, a dust extractor including a nozzle, an extractor housing, a dust tube coupled to the nozzle and slidable between an extended position and a retracted position relative to the extractor housing, and a dust container selectively coupled to the dust extractor housing. A transfer tube is configured to direct air from the dust tube to the dust container, wherein the dust tube includes a cut-out portion aligned with the transfer tube and a cover slidably coupled to the dust tube to selectively enclose the cut-out portion.

The present disclosure provides, in another aspect, a dust extractor including an extractor housing, a dust container including an inlet for receiving dust-laden air, a transfer tube positioned within the extractor housing and arranged to direct the dust-laden air into the dust container, and a dust tube slidable relative to the transfer tube and configured to draw dust-laden air into the dust extractor. The dust tube includes a cut-out portion aligned with the transfer tube to allow the dust tube to slide from an extended position to a retracted position without interference from the transfer tube.

The present disclosure provides, in yet another aspect, a dust extractor including an extractor housing, a dust container selectively coupled to the dust extractor housing, a dust tube slidable between an extended position and a retracted position relative to the extractor housing, a suction fan configured to generate a vacuum air flow within the dust extractor, and a suction motor drivingly engaged with the suction fan. A transfer tube is configured to direct air from the dust tube to the dust container, where the transfer tube positioned forwardly of the suction motor and the suction fan, and where the dust tube includes a cut-out portion aligned with the transfer tube.

Other features and aspects of the invention will become apparent by consideration of the following detailed description and accompanying drawings.

### BRIEF DESCRIPTION OF THE DRAWINGS

FIG. 1 is a front perspective view of an exemplary handheld power tool assembly including a rotary hammer and an exemplary dust extractor.

FIG. 2 is a side view of a dust extractor according to one embodiment, with the dust tube in an extended position.

FIG. 3 is a side view of the dust extractor of FIG. 2 with the dust tube in an intermediate position.

FIG. 4 is a side view of the dust extractor of FIG. 2 with the dust tube in a collapsed position.

FIG. 5 is a bottom perspective view of the dust extractor of FIG. 2, with the dust tube in the extended position.

FIG. 6 is a bottom perspective view of the dust extractor of FIG. 2, with the dust tube in the intermediate position.

FIG. 7 is a bottom perspective view of the dust extractor of FIG. 2, with the dust tube in the collapsed position.

FIG. 8 is a top view of the dust extractor of FIG. 2 with the dust tube in the extended position.

FIG. 9 is a cross-sectional view of the dust extractor of FIG. 2 taken along section line 9-9 in FIG. 8 with the dust tube in the extended position.

FIG. 10 is an enlarged cross-sectional view taken along section line 10-10 in FIG. 9 with the dust tube in the extended position.

FIG. 11 is an enlarged cross-sectional view taken along section line 11-11 in FIG. 9.

FIG. 12 is a cross-sectional view of the dust extractor of FIG. 2 taken along section line 12-12 in FIG. 10 with the dust tube in the extended position.

FIG. 13 is an end view of a cover of the dust extractor of FIG. 2.

FIG. 14 is a first side end view of the housing of the dust extractor of FIG. 2.

FIG. 15 is a cross-sectional view of the dust extractor of FIG. 2 taken along section line 9-9 in FIG. 8 but with the dust tube in the intermediate position.

FIG. 16 is a cross-sectional view of the dust extractor of FIG. 2 taken along section line 9-9 in FIG. 8 but with the dust tube in the collapsed position.

FIG. 17 is a cross-sectional view of the dust tube and the cover taken along section line 17-17 in FIG. 8.

FIG. 18 is a detailed view of the cover.

FIG. 19 is a cross-sectional view of the dust tube and an extractor housing taken along section line 19-19 in FIG. 8.

FIG. 20 is a cross-sectional view of a motor of the dust extractor and the extractor housing taken along section line 20-20 in FIG. 8.

FIG. 21 is a perspective view of the motor of the dust extractor and the extractor housing with a portion of the extractor housing removed.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

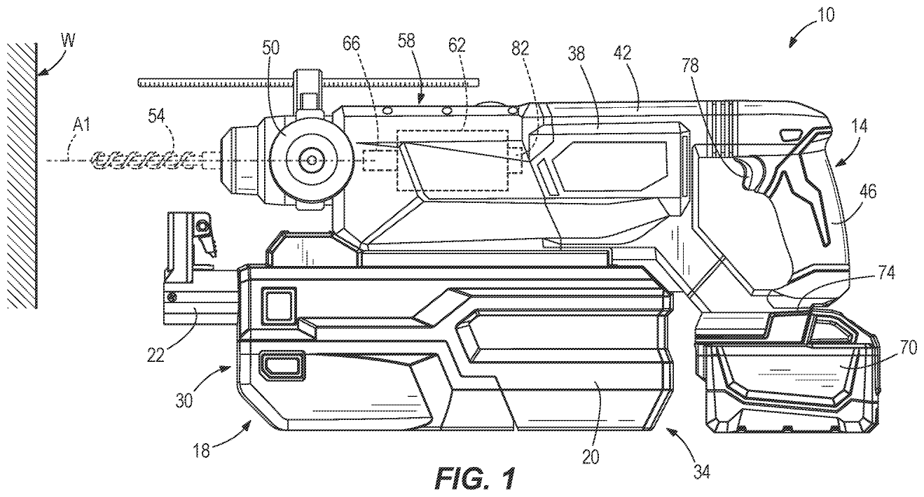

FIG. 1 illustrates a power tool assembly 10 including a power tool 14, such as a rotary hammer 14, and a dust extractor 18, according to one embodiment. The illustrated rotary hammer 14 is operatively connected to the dust extractor 18. In some embodiments, the dust extractor 18 may be removed from the rotary hammer 14 and applied to another power tool 14 or another rotary hammer 14. The dust extractor 18 includes an extractor housing 20 and a telescoping dust tube 22.

The rotary hammer 14 includes a housing 38 having a main body 42 and a handle 46 extending rearward of the main body 42. A chuck assembly 50 is provided on the housing 38 opposite the handle 46. The chuck assembly 50 is operable to receive a tool bit 54 therein. The tool bit 54 extends along a working axis A1 of the rotary hammer 14.

A drive unit 58 is positioned within the main body 42 of the housing 38. The drive unit 58 includes a motor 62 and a drive assembly 66 (i.e., a drive train) operatively coupled to the motor 62 for receiving torque from the motor 62. In the illustrated embodiment, the motor 62 is generally aligned along the working axis A1 of the rotary hammer 14. The working axis A1 extends through the tool bit 54 and the drive assembly 66. The drive assembly 66 if further coupled to the chuck assembly 50 to transmit torque from the motor 62 to the tool bit 54. Power to the motor 62 is provided by a battery 70, which may be received within a battery receptacle 74 on a bottom portion of the handle 46. However, in other embodiments, the battery receptacle 74 may be otherwise located on the rotary hammer 14 or the dust extractor 18. The drive unit 58 further comprises a trigger 78. When the trigger 78 is depressed, current is passed from the battery 70 to the motor 62 to power rotation of the motor 62 and the tool bit 54. In some embodiments, the motor 62 may be coupled to a cooling fan 82 operable to generate a cooling airflow within the housing 38 to pass cool air along the drive unit 58.

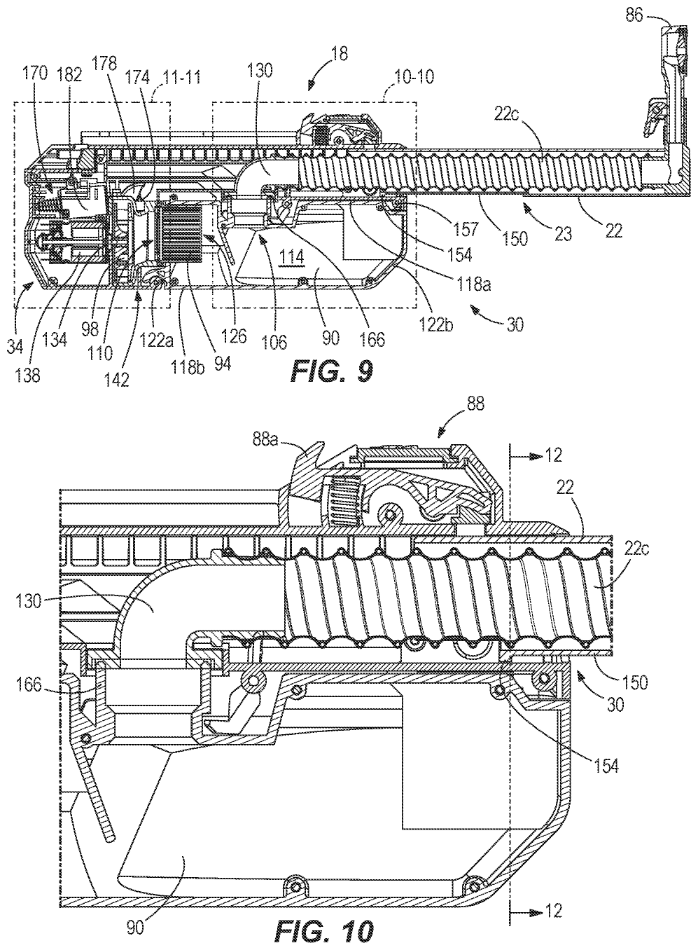

The dust extractor 18 is provided as a separate component distinct from the rotary hammer 14. However, in the assembly (as illustrated in FIG. 1), the dust extractor 18 may be connected to the rotary hammer 14. As illustrated in FIG. 9, for example, the dust extractor 18 includes a nozzle 86, the telescoping dust tube 22, a dust container 90, a filter 94, and a suction fan 98. The nozzle 86 is located at a first end 22a of the telescoping dust tube 22 and proximate to the tool bit 54 of the rotary hammer 14 such that the tool bit 54 extends through the nozzle 86. In other words, the working axis A1 is aligned with the nozzle 86. A second end 22b of the telescoping dust tube 22 is operable to extend and retract from a first end 30 of the dust extractor 18 and towards an opposite second end 34 of the dust extractor 18.

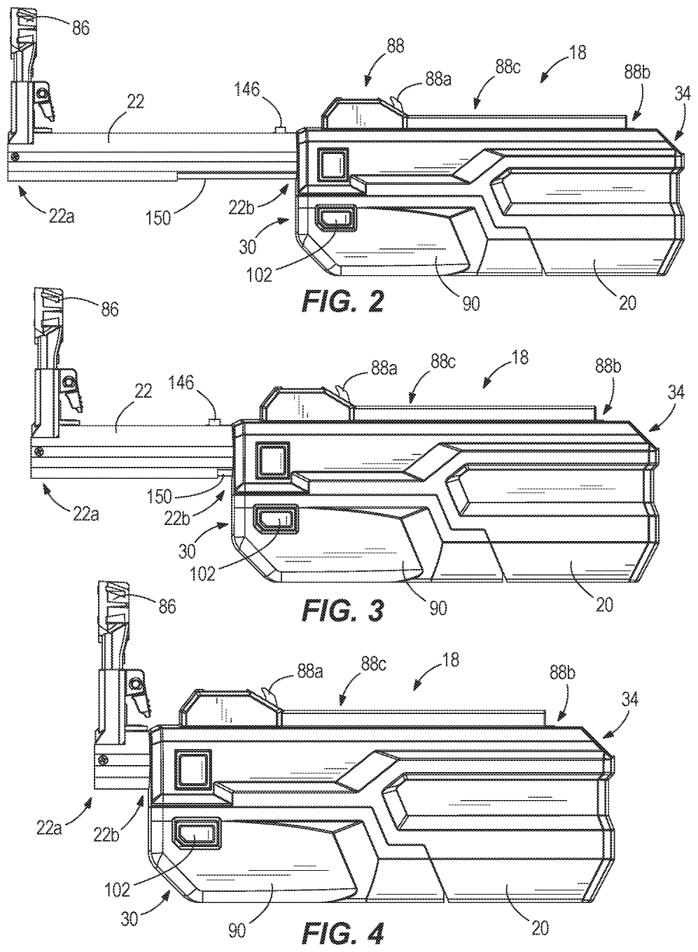

The dust extractor 18 may be secured to the rotary hammer 14 by a connection mechanism 88. The connection mechanism 88 may include a mechanical connection mechanism 88a, 88c and an electrical connection mechanism 88b. As illustrated in FIGS. 2-4, the mechanical connection mechanism 88a may include a spring biased latch to secure the dust extractor 18 to the rotary hammer 14. The mechanical connection mechanism 88a may be actuatable to disconnect the dust extractor 18 from one rotary hammer 14 and may be actuatable to connect the dust extractor 18 to another power tool 14. In the illustrated embodiment, the mechanical connection mechanism 88a is provided adjacent the first end 30. The mechanical connection mechanism 88c may further include a set of rails that slidably engage with a corresponding set of rails on the rotary hammer 14. In the illustrated embodiment, the electrical connection mechanism 88b may be located adjacent the second (i.e., rear) end 34. The electrical connection mechanism 88b may be configured to transmit power and/or a signal between the dust extractor 18 and the rotary hammer 14.

The dust container 90 is selectively attachable to the dust extractor 18. The dust container 90 is detachable from the dust extractor 18 and may be removed to allow an operator to empty the dust and other debris from the dust container 90. A latch 102 is located on either the dust container 90 or the dust extractor 18. The latch 102 is operable to selectively decouple the dust container 90 from the dust extractor 18. In the embodiments illustrated in FIGS. 2-4, the latch 102 is provided on a side wall of the dust container 90, and the latch 102 is movable in a direction towards the interior of the dust container 90 to remove the dust container 90 from the dust extractor 18. In some embodiments, the dust container 90 may be prevented from being secured to the dust extractor 18 without the filter 94 in place. For example, as illustrated in FIG. 9, the filter 94 may act as a portion of the connection between the dust container 90 and the dust extractor 18. Thus, without the filter 94 in place, the dust container 90 is prevented from being coupled to the dust extractor 18.

As illustrated in FIG. 9, the dust container 90 includes an inlet 106 for a dust laden air stream and an outlet 110 defined by an outlet end of the filter 94. More specifically, the dust container 90 includes opposite side walls 114 and top and bottom walls 118a, 118b, respectively extending between the side walls 114. The dust container 90 additionally includes end walls 122 adjacent each of the side walls 114 and the bottom wall 118b. An opening 126 is defined in a first end wall 122a through which the filter 94 is received. The top wall 118a further includes the inlet 106 for dust laden air.

The dust container 90 is in fluid communication with the filter 94. In some embodiments, the filter 94 may be positioned within the dust container 90. In other embodiments, the filter 94 is otherwise located between the dust container 90 and the suction fan 98. In other embodiments, the filter 94 may be positioned in other sections of the dust container 90. In some embodiments, the filter 94 is a high efficiency particulate air (“HEPA”) filter positioned between the dust container 90 and the suction fan 98.

The suction fan 98 is coupled to an output shaft 134 of a suction motor 138. The suction motor 138 is provided within the dust extractor 18. In the illustrated embodiment, the suction motor 138 is distinct from the motor 62 of the rotary hammer 14. The output shaft 134 of the suction motor 138 rotates about a fan axis A2 which is substantially parallel to the working axis A1 when the dust extractor 18 is engaged with the rotary hammer 14. The suction fan 98 rotates about the fan axis A2, and the suction fan 98 is provided forwardly of the suction motor 138. In some embodiments, however, the suction fan 98 may be coupled to the suction motor 138 via other mechanical means such as a clutch, belt, or power take off.

In some embodiments, the suction motor 138 may be electrically coupled to the battery 70 of the rotary hammer 14. In other embodiments, the suction motor 138 may be electrically coupled to another power source (not shown), such as a power source mounted on the dust extractor 18. In some embodiments, the suction motor 138 may be operated when the motor 62 is operated. In other words, the trigger 78 may cause both the motor 62 and the suction motor 138 to rotate. The suction motor 138 may otherwise by caused to operate.

When rotated by the suction motor 138, the suction fan 98 creates an air flow which generates a vacuum in the dust tube 22 (and, more specifically, within a spring tube 22c as discussed in detail below) to draw dust and other debris into the dust container 90 and through the filter 94. After the dust is separated from the air via the filter 94, the clean air is exhausted through an exhaust port 142 formed in the dust extractor 18 adjacent the suction fan 98. The exhaust port 142 may be adjacent the outlet 110.

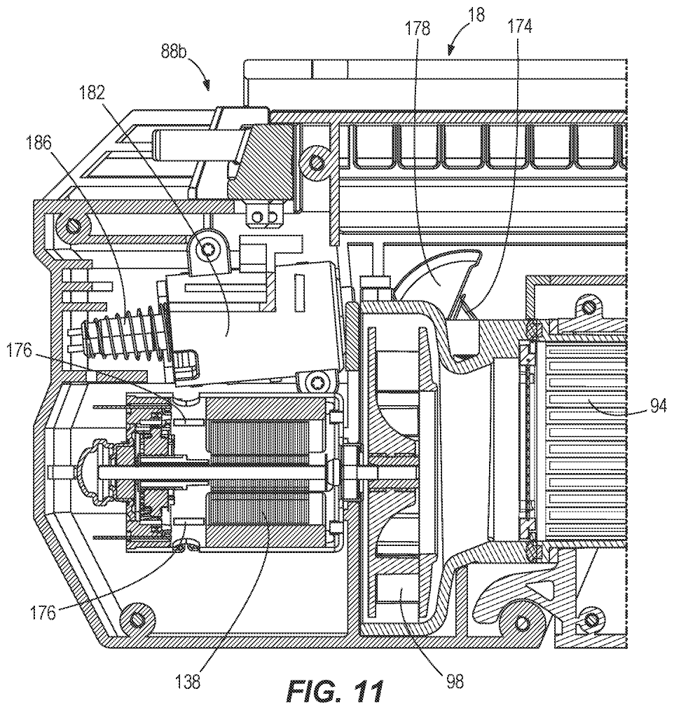

With reference to FIGS. 9 and 11, a filter cleaning mechanism 170 is disposed within the dust extractor 18 and positioned proximate the filter 94. The filter cleaning mechanism 170 includes an anvil 174 for impacting the filter 94, a striker 178 for striking the anvil 174, a solenoid 182 for causing the striker 178 for causing the striker 178 to strike the anvil 174, and a biasing member 186 for biasing the striker 178. In some embodiments, the filter cleaning mechanism 170 may not include an anvil 174. In such embodiments, the striker 178 directly impacts the filter 94. In the illustrated embodiment, the biasing member 186 is a compression spring. The biasing member 186 biases the striker 178 towards a first striker position in contact with the anvil 174 with the anvil 174 spaced from the filter 94 until the solenoid 182 is activated, at which point the solenoid 182 overpowers the biasing member 186 causing the striker 178 to move to a second striker position in contact with the anvil 174 with the anvil 174 contacting the filter 94. In some embodiments, a second biasing member, such as a torsion spring, is coupled to the anvil 174 for biasing the anvil 174 to the first anvil position.

In some embodiments, the filter cleaning mechanism 170 is automatically actuated when the suction fan 98 becomes inactive. A controller (not shown) controls activation of the solenoid 182 which triggers the anvil 174 to contact the filter 94. The impact of the anvil 174 on the filter 94 causes dislodging of dust and other debris from the filter 94. After the anvil 174 impacts the filter 94, the solenoid 182 is automatically deactivated, thereby allowing the anvil 174 and striker 178 to return to pre-impact positions.

Referring to FIGS. 9, 15, and 16, the dust tube 22 is operable to collect dust and other debris from the workpiece W during drilling and/or hammering operation performed by the rotary hammer 14 to maintain a user's work area substantially clear of dust and other debris. Dust collected through the dust tube 22 is directed into the dust container 90, through the filter 94, and clean air is exhausted out of the dust extractor 18. A transfer tube 130 extends through the inlet 106 of the dust container 90 to direct the dust laden air from the dust tube 22 into the dust container 90. In some embodiments, the transfer tube 130 includes a 90 degree bend. In other embodiments, the transfer tube 130 may include a bend of between 0) and 180 degrees. The transfer tube 130 directs the dust laden air into the dust container 90 at a location upstream of the filter 94. Accordingly, the transfer tube 130 is positioned in a central portion of the dust extractor between the first end 30 and the second end 34 of the dust extractor 18. This allow the transfer tube 130 to be positioned as far rearward as possible to provide sufficient room for the dust tube 22 while also ensuring that the dust laden air enters the dust container 90 upstream of the filter 94.

However, because the dust transfer tube 130 is positioned centrally within the dust extractor 18, the dust tube 22 extends beyond the dust transfer tube 130 when the dust tube 22 is in a fully retracted position. In particular, at least a rear end of the dust transfer tube 130 extends beyond or passes as least partially beyond the dust transfer tube 130. In order to allow the dust tube 22 to extend beyond the transfer tube 130 when in the retracted position, the dust tube 22 includes a cut-out portion 23. The cut-out portion 23 is aligned with the transfer tube 130 such that when the dust tube 22 is in the retracted position, the transfer tube 130 extends through the cut-out portion 23.

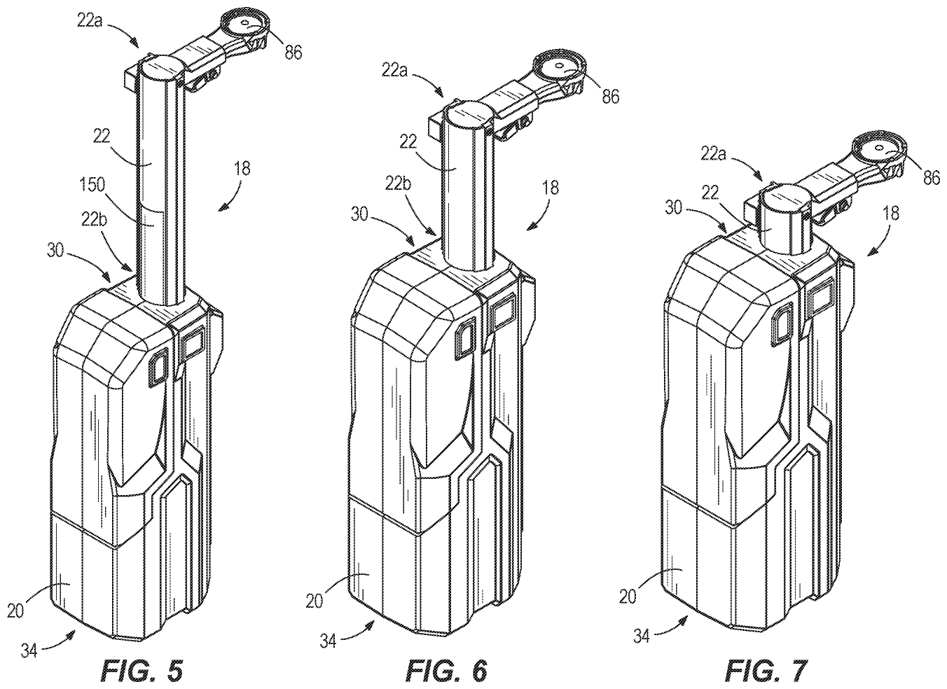

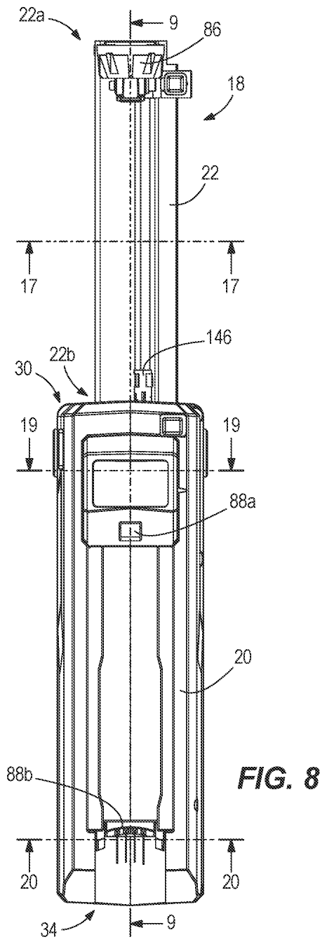

With continued reference to FIG. 9, the dust tube 22 includes a spring tube 22c positioned within the dust tube 22. The spring tube 22c is coupled to both the transfer tube 130 and the nozzle 86. As such, fluid and debris can be passed through the spring tube 22c between the nozzle 86 and the transfer tube 130. In operation of the dust extractor 18, an air vacuum is generated within the spring tube 22c. The air vacuum provides motive force to suck fluid and debris from the nozzle 86, though the spring tube 22c and the transfer tube 130, and into the dust container 90. As the spring tube 22c is located within the dust tube 22, the dust tube 22 provides structural support for the spring tube 22c. The dust tube 22 may inhibit damage of the spring tube 22c. The spring tube 22c is flexible to permit expansion and contraction of the spring tube 22c as the dust tube 22 is translated between the collapsed position (FIG. 7) and the extended position (FIG. 5). It is envisioned that the dust tube 22 may or may not include such a spring tube 22c.

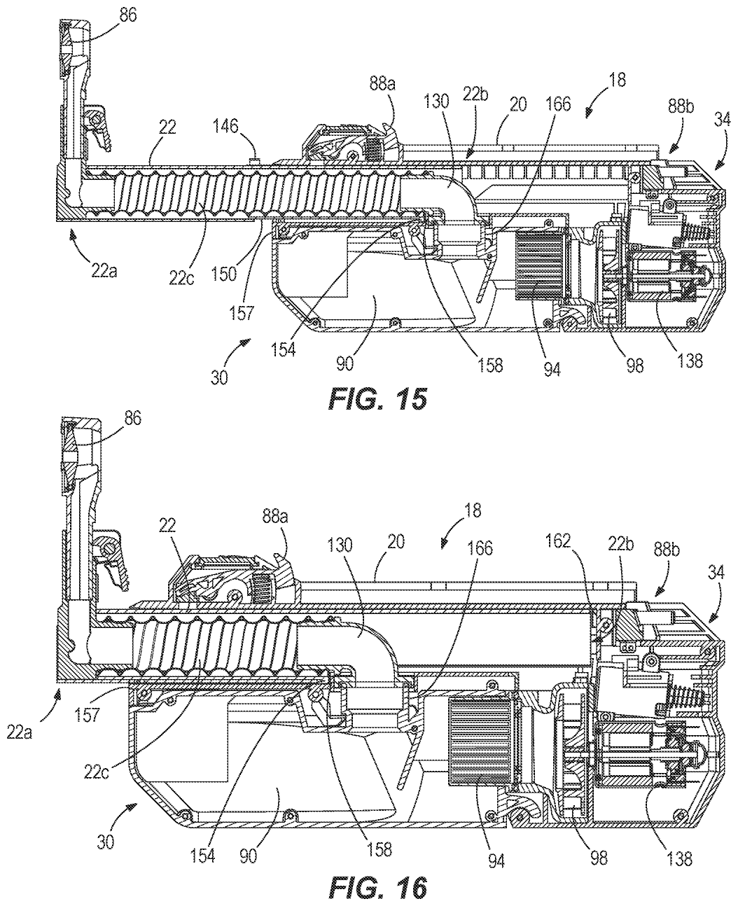

With continued reference to FIG. 9, the dust tube 22 extends longitudinally within the dust extractor 18 in a direction parallel to the working axis A1. The dust tube 22 is configured to slide along its longitudinal axis, thereby adjusting the length of the dust tube 22 outside the housing of the dust extractor 18 and, ultimately, the location of the nozzle 86. The dust tube 22 beings in an extended position, as shown in FIG. 9. As the tool bit 54 plunges into the workpiece, the dust tube 22 retracts into the dust extractor 18 in a telescoping manner, as shown in FIGS. 15 and 16.

As best shown in FIGS. 2 and 3, included within the dust extractor 18 is a plunge depth stop 146, which limits the extent to which the dust tube 22 may retract into the dust extractor 18, and in turn, limits the extent to which the tool bit 54 can plunge into the workpiece. The plunge depth stop 146 is movable along the length of the dust tube 22 and is selectively fixed to limit the extent to which the dust tube 22 may retract into the dust extractor 18.

Also included on the dust tube 22 of the dust extractor 18 is a cover 150, which serves to encloses the cut-out portion 23 of the dust tube 22 to prevent egress of cuttings, dust, and dirty airflow to the surroundings. As previously discussed, the dust tube 22 includes a cut-out portion 23 which allows the dust tube 22 to retract into the housing of the dust extractor 18 without the transfer tube 130 interfering with the movement of the dust tube 22. In order to allow the dust tube 22 to extend beyond the transfer tube 130 the cut-out potion 23 is aligned with the transfer tube 130 such that when the dust tube 22 moves towards the retracted position, the transfer tube 130 extends through the cut-out portion and into a portion of the dust tube 22 (as shown in FIG. 16). However, when the dust tube 22 is in the extended position outside of the housing of the dust extractor 18, the cut-out portion 23 is exposed. Therefore, the cover 150 is configured to close the cut-out portion 23 when then dust tube 22 is extended.

As illustrated in FIGS. 9 and 15-16, the cover 150 is slidably coupled to the dust tube 22. The cover 150 generally moves with the dust tube 22 as the dust tube 22 translates between an extended position and a retracted position. However, the cover 150 may also move relative to the dust tube 22. When the dust tube 22 is in an extended position (FIGS. 9 and 15), the cover 150 is aligned to cover the cut-out portion 23 of the dust tube 22. Specifically, the cover 150 is positioned on a rearward end of the dust tube 22 where it may enclose the cut-out portion 23. When the dust tube 22 is in a retracted position (FIG. 16), the cover 150 is moved towards a forward portion of the dust tube 22 so that dust tube 22 may extend passed the transfer tube 130.

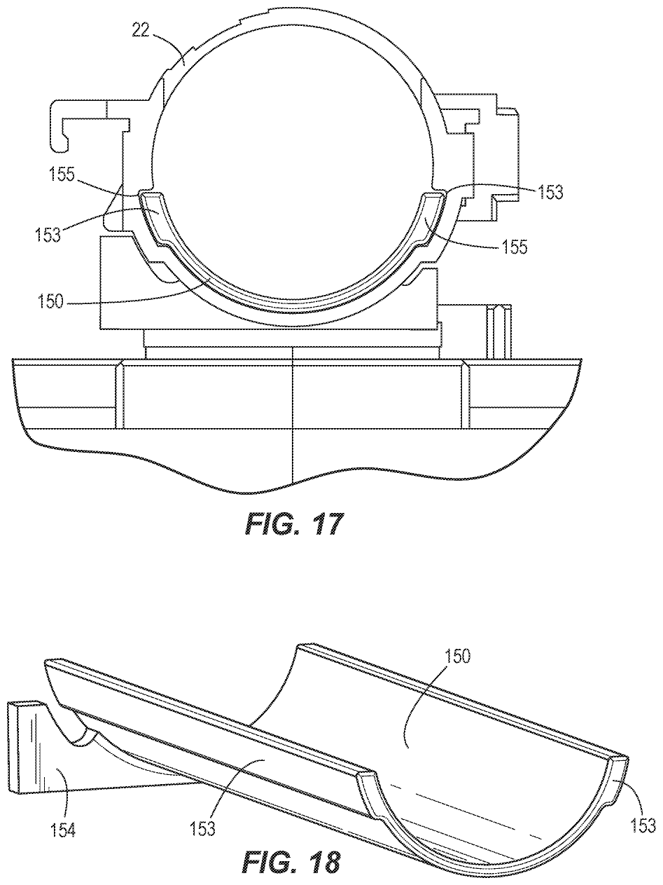

As shown in FIGS. 17 and 18, the cover 150 is shaped as a curved plate, or a partial cylinder that matches the shape of the dust tube 22. In other words, the cover 150 has a curved cross-section corresponding to the curvature (e.g., cross-sectional shape) of the dust tube 22. The length of cover 150 is roughly the same or slightly greater than the length of the cut-out portion 23 of the dust tube 22. In some embodiments, the cut-out portion 23 and the cover 150 extend between 25% and 75% of the length of the dust tube 22. For example in some embodiments, the cut-out portion 23 and the cover 150 are roughly 50% of the length of the dust tube 22. In some embodiments, the cut-out portion 23 and the cover 150 extend at least 30% of the length of the dust tube 22. In some embodiments, the cut-out portion 23 and the cover 150 extend at least 50% of the length of the dust tube 22. The longer the cut-out portion, the more the dust tube 22 is able to overlap the transfer tube 130 without interference. Similarly, the longer the cut-out portion, the more forward the transfer tube 130 may be positioned within the housing 20 without interfering with the dust tube 22.

The cover 150 includes rails 153 that engage with corresponding channels 155 of the dust tube 22 to allow the cover 150 to slide relative to the dust tube 22. The rails 153 and channels 155 create a frictional engagement between the cover 150 and the dust tube 22 such that the cover 150 slides with (i.e., is fixed to) the dust tube 22 when the dust tube 22 translates between the extended position and the retracted position. However, when a counter force overcomes the frictional force between the cover 150 and the dust tube 22, the cover 150 may slide relative to the dust tube 22. Accordingly, the rails 153 and channels 155 allow the cover 150 serve multiple purposes, including securing the cover 150 to the dust tube 22, and allowing relative linear movement of the cover 150 relative to the dust tube 22.

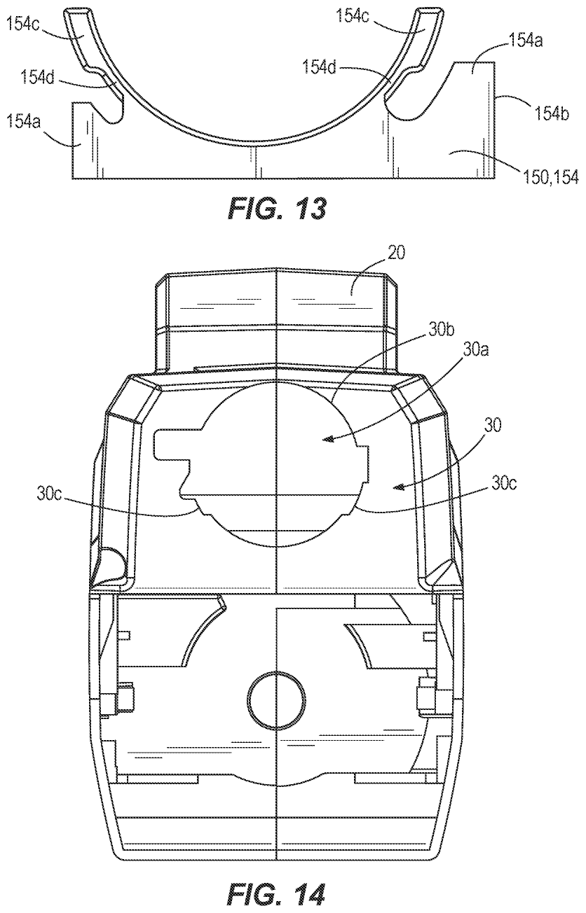

The cover 150 further includes an end plate 154 (shown in FIGS. 13 and 18) to help limit movement of the cover 150. First, the end plate 154 helps to prevent the cover 150 from extending so far out of the dust extractor 18 that it falls out. As the dust tube 22 translates towards the extended position, the cover 150 travels with the dust tube 22. In the extended position (FIGS. 2, 5, 9), the dust tube 22 extends beyond the first end of the dust extractor 18. A portion of the dust tube 22 is located within the dust extractor 18 such that the dust tube 22 remains in fluid communication with the transfer tube 130. As the dust tube 22 moves towards the extended position, the end plate 154 abuts an interior surface 157 of the first end 30 of the dust extractor 18 so to secure the cover 150 within the dust extractor 18 and prevent the cover 150 from falling out of the dust extractor 18.

Additionally, the end plate 154 is also configured to initiate movement of the cover 150 relative to the dust tube 22. When the dust tube 22 translates towards the collapsed position (or the retracted position), the dust tube 22 does not stop translating until it reaches a stop wall 162. However, the cover 150 will stop translation prior to the dust tube 22 translating. Specifically, the end plate 154 is configured to abut a retention wall 158 within the dust extractor 18 before the dust tube 22 reaches the stop wall 162. In some embodiments, the end plate 154 may be configured to abut the transfer tube 130 rather than the retention wall 158. When the end plate 154 comes in contact with either the retention wall 158 or the transfer tube 130, the cover 150 will stop translating along with the dust tube 22 as the dust tube 22 retracts towards a collapsed position. When the cover 150 stops translating, the cut-out portion 23 of the dust tube 22 will be revealed, allowing the dust tube 22 to extend passed the transfer tube 130 without interference.

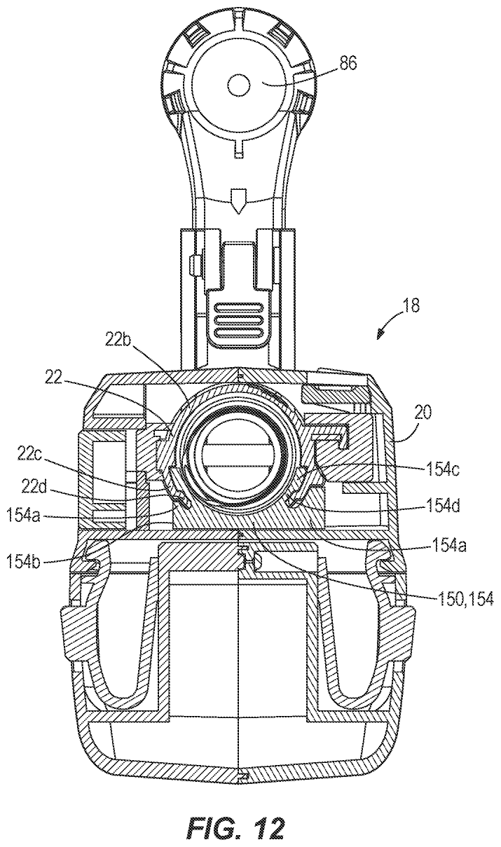

FIGS. 12-14 and 17-18 illustrate the dust tube 22, the cover 150, and the end plate 154 in detail. FIGS. 12 and 17 provide two different cross-sectional view of the cover and the dust tube 22. Referring to FIG. 12, a cross-section of the dust tube 22 includes a cross-sectional periphery 22b having radially extending notches 22c and terminating in tangs 22d which extend radially inwardly from the notches 22c. The end plate 154 includes side tabs 154a and a cross-sectional periphery 154b having radially extending notches 154c. The end plate 154 further includes connection portions 154d which are radially thinner than the notches 154c, the connection portions 154d being located between the side tabs 154a and the notches 154c. The cover 150 includes a cross-sectional periphery 150b that includes similar notches 150c and connection portions 150d. The notches 150c, 154c, are dimensioned to fit within the notches 22c to permit translation between the cover 150 and the dust tube 22. The tangs 22d are dimensioned to slidably engage the connection portions 154d to permit translation between the cover 150 and the dust tube. Referring to FIG. 17, a cross section of the dust tube 22 and the cover 150 illustrates the rails 153 and the channels 155 by which the cover 150 slides relative to the dust tube 22.

FIGS. 13 and 18 illustrate the cover 150 by itself, and FIG. 14 illustrates a first end 30 of the extractor housing 20. The first end 30 is provided with an opening 30a through which the dust tube 22 extends. The opening 30a is defined by a periphery 30b which generally includes cutouts 30c which correspond with the notches 154c. However, the side tabs 154a of the end plate 154 are dimensioned larger than the periphery 30b. As such, the end plate 154 is configured to abut an interior surface of the first end 30 to prevent extraction of the cover 150 from within the dust extractor 18.

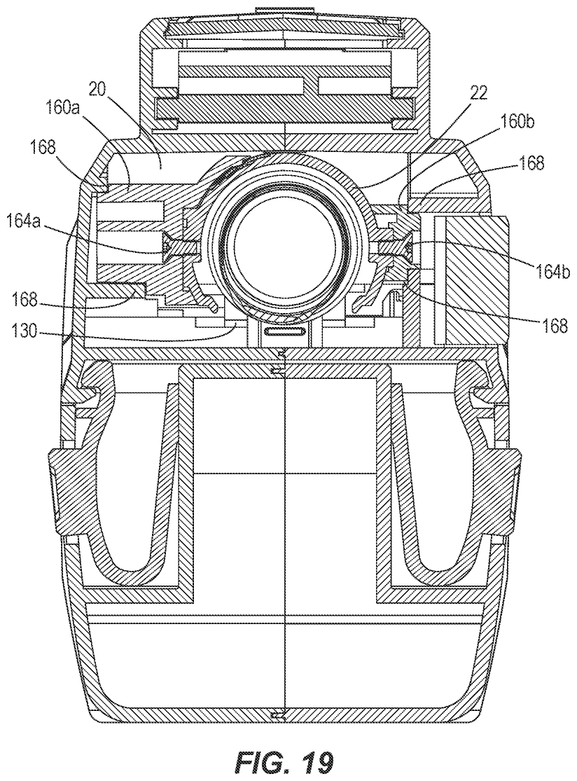

FIG. 19 illustrates a connection between the dust tube 22 and the extractor housing 20. In the illustrated embodiment, two bushings 160a, 160b are positioned between the dust tube 22 and the extractor housing 20. The bushings 160a, 160b are attached to the dust tube 22 by fasteners 164a, 164b, respectively. The extractor housing 20 includes features 168 (such as protrusions, ledges, and channels) which are sized and shaped to slidably support the bushings 160a, 160b with respect to the extractor housing 20. For example, some of the features 168 function as rails to slidably support the bushings 160a, 160b. In the illustrated embodiment, the features 168 are provided adjacent opposite side surfaces of each bushing 160a, 160b to constrain the translation of the dust tube 22 in an axial direction. In the illustrated embodiment, the bushings 160a, 160b are slidable along the features 168 in a direction parallel to the working axis A1 (into and out of the page as viewed in FIG. 19). As such, both the dust tube 22 and the cover 150 are translatable between the extended position and the retracted position.

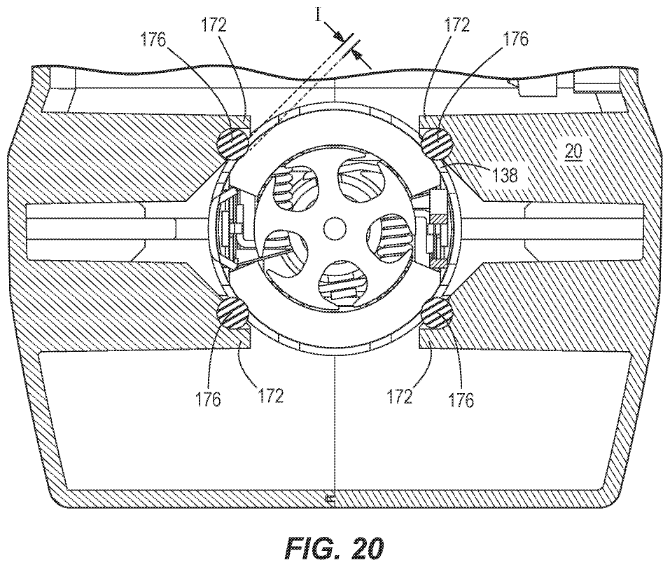

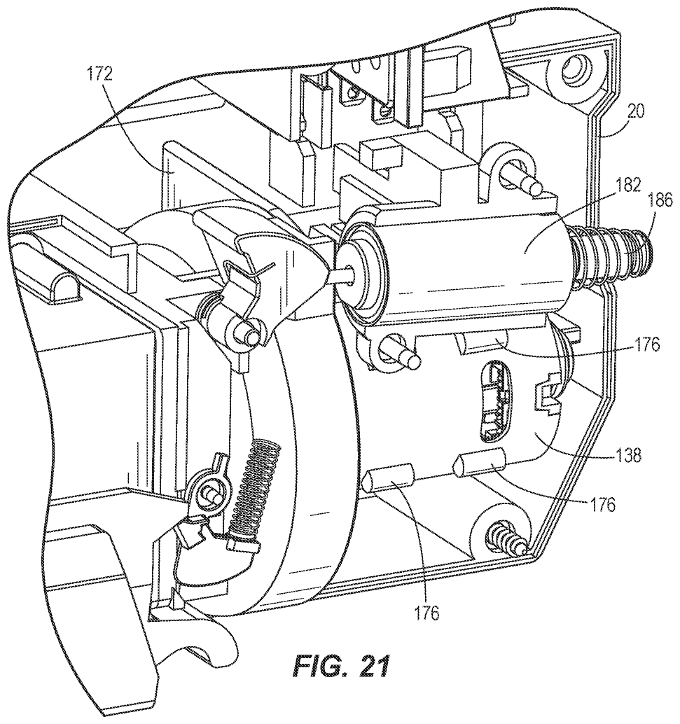

FIGS. 20 and 21 illustrate a connection between the suction motor 138 and the extractor housing 20. The extractor housing 20 includes arms 172 configured to secure the suction motor 138 to the extractor housing 20. In the illustrated embodiment, the arms 172 protrude radially inwardly from the exterior of the extractor housing 20 towards the suction motor 138. The arms 172 are dimensioned to receive bumpers 176 therein. The bumpers 176 are positioned between the arms 172 and the suction motor 138. The bumpers 176 are dimensioned such that an interference fit is achieved between the suction motor 138, the bumpers 176, and the arms 172. The bumpers 176 are deformable to take up the space between the suction motor 138 and the arms 172. In the illustrated embodiment, the bumpers 176 are cylindrical in geometry. Other geometries of the bumpers 176 are possible. In the illustrated embodiment, the bumpers 176 are cylindrical prior to securing the suction motor 138 within the arms 172, and the bumpers 176 are a deformed generally cylindrical geometry when the bumpers 176 secure the suction motor 138 within the arms 172. FIG. 20 illustrates the bumpers 176 in a cylindrical geometry with an interference fit between the suction motor 138 and the arms 172.

The bumpers 176 secure the suction motor 138 from rotating undesirably within the extractor housing 20. The bumpers 176 dampen vibration of the suction motor 138 from passing to the extractor housing 20. The bumpers 176 are elastic, and are capable of reciprocally being deformed between the cylindrical shape and the deformed cylindrical shape during use of the dust extractor 18. In the illustrated embodiment, the bumpers 176 are separate pieces from the extractor housing 20. In other words, in the illustrated embodiment, the bumpers 176 are positioned on the arms 172 during assembly of the suction motor 138 within the extractor housing 20. The illustrated bumpers 176 are separate from the arms 172. However, in other embodiments, the bumpers 176 may be integral with the arms 172.

Although the invention has been described in detail with reference to certain preferred embodiments, variations and modifications exist within the scope and spirit of one or more independent aspects of the invention as described.

Various features and advantages of the invention are set forth in the following claims.

What is claimed is:

1. A dust extractor comprising:
a nozzle;
an extractor housing;
a dust tube coupled to the nozzle and slidable between an extended position and a retracted position relative to the extractor housing;
a dust container selectively coupled to the dust extractor housing; and
a transfer tube configured to direct air from the dust tube to the dust container;
wherein the dust tube includes a cut-out portion aligned with the transfer tube and a cover slidably coupled to the dust tube to selectively enclose the cut-out portion.

2. The dust extractor of claim 1, wherein a rear end of the dust tube extends beyond the transfer tube when the dust tube is in the retracted position.

3. The dust extractor of claim 1, wherein the transfer tube extends through the cut-out portion and into the dust tube when the dust tube is in the retracted position.

4. The dust extractor of claim 1, wherein the cover and the dust tube are in frictional engagement, wherein the frictional engagement enables the cover to translate with the dust tube when the dust tube translates between the extended position and the retracted position, and wherein the frictional engagement enables the cover to slide relative to the dust tube when a counter force is applied

5. The dust extractor of claim 1, wherein one of the cover and dust tube includes a rail and the other of the cover and the dust tube includes a channel.

6. The dust extractor of claim 1, wherein the cover includes an end plate on a first end of the cover, the end plate configured to limit movement of the cover relative to the dust tube.

7. The dust extractor of claim 6, further comprising a retention wall, wherein the end plate abuts the retention wall when the dust tube slides towards the retracted position.

8. The dust extractor of claim 6, wherein the end plate abuts an interior surface of the housing when the dust tube slides towards the extended position.

9. The dust extractor of claim 1, wherein the cover has a curved shape corresponding to a cross-sectional shape of the dust tube.

10. The dust extractor of claim 1, wherein the transfer tube includes a bend of between 0 degrees and 180 degrees.

11. A dust extractor comprising:
an extractor housing;
a dust container including an inlet for receiving dust-laden air;
a transfer tube positioned within the extractor housing and arranged to direct the dust-laden air into the dust container; and
a dust tube slidable relative to the transfer tube and configured to draw dust-laden air into the dust extractor, the dust tube including a cut-out portion aligned with the transfer tube to allow the dust tube to slide from an extended position to a retracted position without interference from the transfer tube.

12. The dust extractor of claim 11, wherein a rear end of the dust tube extends beyond the transfer tube when the dust tube is in the retracted position.

13. The dust extractor of claim 11, wherein the transfer tube extends through the cut-out portion and into the dust tube when the dust tube is in the retracted position.

14. The dust extractor of claim 11, wherein the cut-out portion extends at least 30% of the length of the dust tube.

15. The dust extractor of claim 11, wherein the cut-out portion extends at least 50% of the length of the dust tube.

16. The dust extractor of claim 11, further comprising a suction motor coupled to a suction fan, wherein the transfer tube is positioned forwardly of the suction motor and the suction fan within the extractor housing.

17. A dust extractor comprising:
an extractor housing;
a dust container selectively coupled to the dust extractor housing;
a dust tube slidable between an extended position and a retracted position relative to the extractor housing;
a suction fan configured to generate a vacuum air flow within the dust extractor;
a suction motor drivingly engaged with the suction fan; and
a transfer tube configured to direct air from the dust tube to the dust container, the transfer tube positioned forwardly of the suction motor and the suction fan,
wherein the dust tube includes a cut-out portion aligned with the transfer tube.

18. The dust extractor of claim 17, wherein the transfer tube extends through the cut-out portion and into the dust tube when the dust tube is in the retracted position.

19. The dust extractor of claim 18, wherein the dust tube includes a cover arranged to close the cut-out portion when the dust tube is in the extended position.

20. The dust extractor of claim 19, wherein the cover is slidingly coupled to the dust tube.
